(19) United States
(12) Patent Application Publication
(10) Pub. No.: US 2004/0028055 A1
(43) Pub. Date: Feb. 12, 2004

(54) Differentiated accounting in a packet data network

(76) Inventors: Lila Madour, Kirkland (CA); Ghyslain Pelletier, Lulea (SE)

Correspondence Address: ALEX NICOLAESCU, Ericsson Canada Inc., Patent Department, 8400 Decarie Blvd., Montreal, QC, H4P 2N2, CA

(21) Appl. No.: 10/449,130

(22) Filed: Jun. 2, 2003

Related U.S. Application Data
(60) Provisional application No. 60/398,559, filed on Jul. 26, 2002.

(51) Int. Cl. H04L 12/56

(52) U.S. Cl. 370/395.21

(57) ABSTRACT

A method, system and Packet Data Access Node (PDAN), such as a Packet Data Service Node (PDSN) of a CDMA2000 network, for performing accounting based not only on the IP address of a terminal associated with the PDAN (e.g. a Mobile Station), but also on information related to a Corresponding Node (CN) with which the terminal communicates over a packet data session, such as the CN IP address, and possibly the CN application ID or port number, and the Quality of Service (QoS) for that session. The session is established between the terminal and the CN using Session Initiation Protocol (SIP) signalling, and the PDAN is provided with the CN's related information by a Proxy Call Switch Control Function (P-CSCF). The PDAN counts the traffic associated with the CN's IP address, and reports that traffic, along with the CN's information to an Authorization, Authentication, and Accounting server (AAA). Accounting can then be applied based on the CN'related information.

### PRIORITY STATEMENT UNDER 35 U.S.C. S.119(e) & 37 C.F.R. S.1.78

This non-provisional patent application claims priority based upon the prior U.S. provisional patent application entitled “SIGNALING OF REMOTE IP ADDRESS FOR ACCOUNTING VIA P-CSCF IN IP MMED DOMAIN”, application No. 60/398,559, filed Jul. 26, 2002, in the names of Lila MADOUR and Ghyslain PELLETIER.

### BACKGROUND OF THE INVENTION

1. Field of the Invention

The present invention relates to a method and system for accounting in a packet data network.

2. Description of the Related Art

CDMA2000, also known as IMT-CDMA Multi-Carrier or IS-95, is a Code-Division Multiple Access (CDMA) version of the IMT-2000 standard developed by the International Telecommunication Union (ITU). The CDMA2000 standard is a 3rd Generation (3G) mobile wireless technology allowing mobile users to access IP-based high-speed voice and data traffic over the CDMA-based cellular network. Characteristically, CDMA2000 can support mobile data communications at speeds ranging from 144 kbps to 2 Mbps.

A typical CDMA2000 network comprises a number of nodes including one or more Mobile Stations (MSs), one or more Base Stations (BSs), one or more Packet Control Functions (PCFs) and one or more Packet Data Serving Nodes (PDSNs), or their equivalent. The BSs may be connected to the PCF, which is an entity in the CDMA2000 Radio Access Network (RAN) that controls the transmission of data packets between the BSs and the PDSN. The PCF is in turn connected with the PDSNs. In order to provide IP Multimedia Services (MMS) to the MS subscribers over the CDMA2000 wireless system, a Session Initiation Protocol (SIP) server, or a Call Switch Control Function (CSCF) is also required.

SIP is an Internet Engineering Task Force (IETF) standard protocol for initiating an interactive user session that may involve multimedia elements such as video, voice, chat, gaming, and virtual reality. Like HTTP and SMTP, SIP works in the application layer of the Open Systems Interconnection (OSI) communications model. SIP can establish multimedia sessions or Internet telephony calls, modify, or terminate them, on top on an existing network such as the CDMA 2000 network. SIP can also invite participants to unicast or multicast sessions that do not necessarily involve the initiator. Because SIP supports name mapping and redirection services, it makes it possible for users to initiate and receive communications and services from any location, and for networks to identify the users wherever they are. SIP is a request-response protocol, dealing with requests from clients and responses from servers. Participants are identified by SIP Uniform Resource Locators (URLs). Requests can be sent through any transport protocol, such as UDP, SCTP, or TCP. SIP determines the end system to be used for the session, the communication media and media parameters, and the called party's desire to engage in the communication. Once these are assured, SIP establishes call parameters at either end of the communication, and handles call transfer and termination. SIP is specified in IETF Request for Comments RFC 2543, and RFC 3261, both of which are herein included by reference.

In the CDMA 2000 network, the PDSN provides access to the Internet, intranets and applications servers for mobile stations utilizing the CDMA2000 RAN. Acting as an access gateway, the PDSN provides simple IP and mobile IP access, foreign agent support, and packet transport for virtual private networking. It acts as a client for an Authorization, Authentication, and Accounting server (AAA) and provides mobile stations with a gateway to the IP network.

Finally, a Proxy CSCF (P-CSCF) is the terminals' point of contact in the serving network once the MS′ registration has taken place. One of the primary functions of the P-CSCF is to be the Quality of Service (QoS) policy enforcement point within the visited IP Multimedia Subsystem (MMS) network, i.e. the point where the network places constraints on the bearer. The MS registers and initiates sessions via the P-CSCF which proxies all MS requests to a Serving CSCF (S-CSCF), which is responsible for identifying the MS user's service privileges, for selecting access to the home network application server (service platform) and for providing access to that server. One of the primary functions of the S-CSCF is to perform session management for the MMS network. The S-CSCF of the home network is responsible for all session control, but depending of the particular implementation, may forward specific requests to a P-CSCF in the visited/serving network based on the requirements of the request.

The AAA server of the CDMA2000 network intelligently controls access to network resources, enforces policies, audits the usage, and provides the information necessary to bill for the services accessed by the MSs. These combined processes are essential for effective network management and security.

Typically, the AAA server gathers accounting information as received by the network entities based on the number of data packets exchanged by the MS with the network or duration of the data session. For this purpose, the AAA server typically receives accounting messages from the PDSN involved in the establishment of the data session for the given MS. In current CDMA2000 implementations, the PDSN generates accounting by counting the IP packets/octets associated with the IP address assigned to the MS, or metering the duration of the data session, before sending the accounting messages to the AAA server. Thus, in existing CDMA2000 networks, the packet data accounting is based on the IP address and the Network Access Identifier (NAI) of the MS involved in the data communication, which allows the serving PDSN to which the MS is connected, typically via a Point-to-Point Protocol (PPP) connection, to monitor the data session and to report the result to the AAA server.

However, in certain wireless systems, it is also desirable not only to perform accounting based on the IP address of the MS attached to the PDSN, but also based on information related to the second party involved in a data communication (IP server, terminal, other MS, etc), in order to provide the service provider the flexibility to charge differently based on the equipment and/or resources used by the MS to receive the service. It would be particularly desirable to perform accounting based on the identity of that second party involved in a data session and also on the type of application used by that second party. For example, this can allow packet data downloaded by an MS from a certain server via HTTP to be charged using a first rate, while IP-based voice communications of an MS with another MS to be charged using a second, regular rate. The Third Generation Partnership Project 2 (3GPP2) has recognized the need for a more complete accounting mechanism for CDMA 2000 networks allowing accounting based on the IP address of the second party involved in a given data communication.

To be able to perform such 2^{nd} party and service/application based accounting, the packet data access node (i.e. the PDSN) that performs the accounting in the serving network requires to know the remote IP address and port number used by the corresponding 2^{nd} party for that particular service/application, and optionally the type of accounting required (off-line or on-line (prepaid). The matter is being preliminarily discussed by 3GPP2, and intermediate partial solutions have been proposed by 3GPP2 members, wherein the remote IP address of the second party involved in the data session is either provisioned locally or received by the AAA server upon access authorization of the MS. When provisioned locally, the IP address must be synchronized with a home network where billing up is being performed.

The existing state-of-the-art solutions for remote IP-address accounting create strong limitations and processing requirements for the network's PDSNs, as each remote IP-address must be scanned against a list of IP-addresses that are first, not used by the MSs and second, used by special nodes for which a different kind of billing should be performed. In such an implementation, the PDSN comprises a list where one entry corresponds to an IP address/accounting key pair, each pair representing for example a specific service that requires a special billing. The list may be common for every MS supported by the PDSN, or individual to each MS, but will likely contain all the possible services for which the operator implemented differentiated billing. The total data of the list can sum up to a very large number of entries, although most entries may never or very seldom be used by the MS. When a new data flow goes through the PDSN from an MS to a corresponding 2^{nd} party, the PDSN does not know if a special accounting is associated to the IP address of the 2^{nd} party until it looks into the list and either finds an entry matching the 2^{nd} party IP address or alternatively, until all the list's entries have been looked at without identifying a match. This procedure is process-intensive for the PDSN resources, and its intensity increases proportionally with the size of the list. This creates a heavy burden on the performance of the PDSNs that implement differentiated accounting support. In addition, in some implementations, when the IP-addresses are provisioned with the list to the PDSN, the provisioning must be synchronized with a home network list of IP addresses/port numbers to facilitate billing consolidation. The IP addresses' synchronization is a real burden on network operators, as at the present moment such synchronization's method are neither defined nor standardized.

Although there is no prior art solution as the one proposed hereinafter for solving the above-mentioned deficiencies, the International Patent Application number WO 01/24476 bears some relation with the field of the present invention. It teaches a method and system for routing AAA messages including a source NAI and optionally a destination and NAI. A number of AAA messages are received and a determination is made whether the messages include a destination NAI. If no destination NAI is present, a user's NAI is retrieved from the message, and a determination is made whether the user NAI's domain is local, and routing of the message is done accordingly. If the destination NAI is present in the message, a determination is made whether the destination NAI domain is local, and the message is routed accordingly.

The International Patent Application number WO 01/24476 fails to teach or suggest the method and system for remote IP address based accounting as disclosed in the present invention.

Accordingly, it should be readily appreciated that in order to overcome the deficiencies and shortcomings of the existing solutions, it would be advantageous to have a method and system for effectively supporting remote IP address and application based accounting in a packet data network. The present invention provides such a method and system.

### SUMMARY OF THE INVENTION

A method for charging in a packet data system, the method comprising the steps of:

a) initiating a packet data session between an IP-based terminal having assigned an MS IP address, and an IP-based Corresponding Node (CN) having assigned a CN IP address;

b) providing a Packet Data Access Node (PDAN) with CN's related information including the CN IP address;

c) using the CN IP address of the CN, determining by the PDAN an amount of data exchanged by the CN with the MS during the packet data session; and

d) reporting the amount of data from the PDAN to an Authorization, Authentication, and Accounting server (AAA).

A packet data system comprising:

an IP-based terminal having assigned a terminal IP address;

an IP-based Corresponding Node (CN) having assigned a CN IP address;

a Packet Data Access Node (PDAN); and

an Authorization, Authentication, and Accounting server (AAA);

wherein when a packet data session is established between the IP-based terminal and the IP-based CN, the PDAN is provided with CN's related information including the CN IP address and based on the CN IP address, the PDAN determines an amount of data exchanged by the CN with the MS during the packet data session, and reports the amount of data to the AAA server.

A Packet Data Access Node (PDAN) acting to support a packet data session between an IP-based terminal having assigned a terminal IP address and an IP-based Corresponding Node (CN) having assigned a CN IP address, wherein when a packet data session is established between the IP-based terminal and the IP-based CN, the PDAN receives CN's related information including the second IP address of the CN and, based on the second IP address of the CN, the PDAN determines an amount of data exchanged by the CN with the MS during the packet data session, and reports the amount of data to an Authorization, Authentication, and Accounting server (AAA).

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 is a nodal operation and signal flow diagram of an exemplary packet data network implementing the preferred embodiment of the present invention associated with an origination of a packet data session by a Mobile Station (MS); and

FIG. 2 is another a nodal operation and signal flow diagram of an exemplary packet data network implementing the preferred embodiment of the present invention associated with a termination of a packet data session to an MS.

### DETAILED DESCRIPTION OF THE PREFERRED EMBODIMENTS

The innovative teachings of the present invention will be described with particular reference to various exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views.

The present invention provides an accounting method and system for allowing charging based not only on the IP address of a first MS involved in a packet data session but also on information related to a second party involved in that communication, hereinafter called the Corresponding Node (CN), which information may comprise the CN's IP address, the CN's port number or application type, the required Quality of Service (QoS) for the specified data session, and the Accounting Type (AT) to be used for that subscriber (prepaid, postpaid). Exemplary instances wherein such accounting may be desirable can be, for example, when:

a first MS is involved in a data communication with a second MS, and accounting is to be performed based on the second MS′ IP address and port number, i.e. on the amount of packet data traffic and on the application type associated with that second MS′ IP address; in this case the CN is another MS;

a first MS is involved in a data communication with an IP server (e.g. a content provider server such as an HTTP news server), and accounting is to be performed based on the IP server's IP address and application (HTTP) used for that data communication, i.e. on the packet data traffic associated with the server's IP address; in this case the CN is an IP server.

Thus, it is contemplated that the CN may be, for example, a server of any kind, such as a content provider server, another MS, or any other type of IP node associated with one or more IP addresses, capable of carrying IP data sessions. The present solution allows a Session Initiation Protocol (SIP) server or a CSCF to dynamically provision the CN's related information, including the CN's IP address, optionally a port number, and a required QoS for accounting purposes to the PDSN (or to any other equivalent packet data access node), and optionally further indicate which type of accounting is to be performed (prepaid vs postpaid). For this purpose, according to the present invention, the P-CSCF sends the CN's related information received in the SIP INVITE (or SIP 100/183) messages to the serving PDSN/HA (Home Agent) (or to any other equivalent packet data access node, although in the present exemplary scenario the PDSN is assumed to be the packet data access node). When the PDSN receives the CN's related information, it can provide an exact accounting of data packets matching the received header information (i.e. IP address, port number) for the remote IP address, from the moment the session has started until it ends. The PDSN is notified when a particular session ends by the P-CSCF, and then reports to the corresponding AAA server the total number of data packets exchanged by the CN with the MS, so that charging for the given MS can be performed based on the amount of traffic received, or transmitted, by the particular application of the CN that used the data session.

An example of a suitable situation when a wireless network operator would desire to charge differently a subscriber of an MS based on the remote IP address/port number of a CN, is when the MS subscriber downloads, for example, JAVA executable games for its MS. The MS may establish a packet data session with the operator's content provider server (the CN), and download 2 games in the amount of, for example, 100 Kb. With the present invention, the operators' AAA server is notified that the 100 Kb of data are downloaded from a specific server (the CN) associated with an IP address and application (e.g. FTP) for which a different, lower charge is to be applied, since the operator set a lower rate for subscribers downloading its own JAVA executable games.

According to the present invention, when the P-CSCF receives a SIP invite message from a CN (or from the MS) to establish a new IP data session, it processes and sends the request to the other participant. A new connection is established that can suit the QoS required for the session. Upon establishing the new connection, the PDSN signals to the P-CSCF that a connection is established and provides the identity of the connection. A message is triggered form the PDSN to the P-CSCF to indicate the bearer is established. The P-CSCF responds back to the PDSN and includes the IP address/port number (and optionally the QoS) of the CN that will be sending data packets to the MS for accounting purposes, and may indicate the accounting type. The PDSN stores the information and begins counting incoming and outgoing packets from and to the remote IP address corresponding to the IP address received by the P-CSCF. When the session is terminated, which may be triggered by a release of the connection from the RAN or the MS or by the P-CSCF signalling the release after receiving the SIP BYE message, the PDSN reports the result of the accounting for the particular remote IP address to the AAA server. The same scenario may also apply when the P-CSCF receives SIP 100 or SIP 183 for an originating multimedia session establishment.

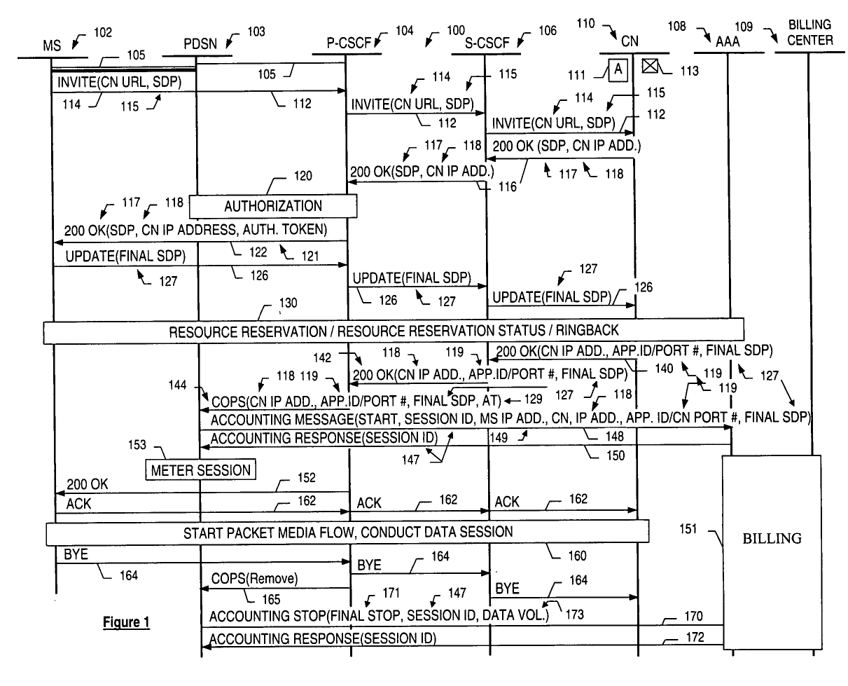

Reference is now made to FIG. 1, which is a nodal operation and signal flow diagram of an exemplary packet data network 100 implementing the preferred embodiment of the present invention associated with the origination of a packet data session by a Mobile Station 102. The exemplary network 100 may be a CDMA2000 network that comprises the MS 102 receiving wireless service via a Packet Data Service Node (PDSN) 103, and that may function according to the standard 3GPP2 P.S0001—TIA/EIA IS-835 CDMA2000 Wireless IP, herein included by reference. Further, it is assumed for the present exemplary scenario that the MS 102 is connected to the PDSN 103 via a Point-to-Point Protocol (PPP) session 105 as known in the art, and that it can also be provided with IP MultiMedia Services (MMS) via a Proxy Call State Control Function (P-CSCF) 104 and a Serving Call State Control Function (S-CSCF) 106. Finally, an Authentication, Authorization and Accounting (AAA) server 108, together with a billing center 109 are responsible for the charging with respect to the packet data traffic within the network 100. The MS 102 is also assumed to be able to establish packet data sessions with a Corresponding Node (CN) 110 that runs at least an application 111 communicating via the CN's port 113 with network entities external to the CN.

According to the present invention, it is also assumed that a packet data communication interface 105 is defined and exists between the PDSN 103 and the P-CSCF 104, as it is currently being discussed by the 3GPP2. The present invention takes advantage of the present interface 105 by allowing the CN's related information, including the IP address and the application used by the CN, to be transmitted to the PDSN.

With reference being further made to FIG. 1, the originating party, i.e. the MS 102, initiates the establishment of an MMS data session with the CN 110 using the Session Initiation Protocol (SIP), by issuing a SIP INVITE message 112 comprising a CN Uniform Resource Locator (URL) 114 identifying the CN, as well as Session Description Protocol (SDP) parameters 115 comprising the requested media types and formats for the data session as well as session information such as session identification, network type, address type and address elements. The INVITE message 112 is sent to the P-CSCF 104, which may be determined via a CSCF discovery mechanism, as it is known in the art. In GPRS-based networks, this is achieved using DHCPv6 as specified in the standard set by the Internet Engineering Task Force (IETF) specification draft-ietf-dhc-dhcpv6 along with the options for SIP servers from the IETF specification draft-ietf-sip-dhcpv6, both of which are herein included by reference. Alternatively, the CSCF discovery mechanism may include transferring the P-CSCF address(es) within the PDP context activation procedure, or any other suitable procedure. The P-CSCF 104 forwards the message 112 to the S-CSCF 106, which in turn validates the service profile of the MS 102 (not specifically shown), and performs any origination service control required for the MS (actions not shown). This may include authorization of the requested SDP session parameters based on the MS 102 user's subscription for MMS. The S-CSCF 106 further relays the SIP INVITE message 112 to the CN 110, which in order to accept the data session, may respond with a SIP 2000K message 116 transmitted via the S-CSCF 106 to P-CSCF 104 and comprising a new set of SDP media stream capabilities 117 specified by the CN 110 as well as the CN IP address 118. In action 120, the P-CSCF 104, possibly in combination with the PDSN 103, authorizes the resources necessary to the data session and may further generate, as a result of the authorization 120, an authorization token 121, which is then forwarded in a 2000K message 122 to the originating MS 102 along with the SDP media stream capabilities 117, and the CN IP address 118. Based on the SDP media stream capabilities 117 specified by the CN 110 and received in message 122, the MS 102 can decide the final set of media streams settings for the data session, and may send a SIP UPDATE message 126 with the final SDP parameters 127, via the P-CSCF 104 and the S-CSCF 106, to the CN 110. In action 130, the MS 102 initiates the reservation procedures for the resources needed for this data session. Part of action 130, when the resources' reservation is completed, the MS 102 sends a resource reservation successful message to the termination endpoint, i.e. to the CN 110, via signalling established by the SIP INVITE message 112. The resources reservation successful message is also sent through the P-CSCF 104 and the S-CSCF 106 to the CN 110, which may optionally perform ringing/alerting, in which situation it signals to the MS 102, via the S-CSCF 106 and the P-CSCF 104, a provisional response indicating ringing.

When the CN 110 answers, it sends a SI P 2000K final response 140 to the S-CSCF 106, which may perform service control that is further appropriate for the session setup and, when completed, sends a SIP 2000K final response 142 to the P-CSCF 104, wherein according to the present invention, the messages 140 and 142 include the CN's related information, i.e. the CN IP address 118, the identity 119 of the application 11 used by the CN for that data session, which may have the form of an application port number, and the final SDP 127 negotiated for the data session including the session's QoS.

According to the invention, the P-CSCF 104 indicates the resources reserved for this data session should now be committed by communicating with the PDSN 103 via, for example, a Common Open Policy Service (COPS) Protocol message 144 that may comprise the CN's related information, i.e. CN IP address 118, the application ID/port number 119 and optionally the Quality of Service (QoS) parameter 127, and the Accounting Type (AT) parameter 129 indicative of what type of accounting is to be performed for this data session for the MS 102 (prepaid vs postpaid). In one variant, the COPS message 144 may be a COPS DECISION message comprising an Install command with the parameters of the CN's related information, although it is understood that the message 144 may be of any other type as well.

The PDSN 103 then starts metering the data session based on the information received in the message 144, and depending upon the type of requested accounting, it sends an Accounting Start message 148 to the AAA server 108 for informing the former of the new data session that is being established. The message 148 may comprise a start parameter 145 indicative of a new data session, a session ID parameter 147 identifying the new accounting session, the MS IP address 149, the CN IP address 118, the CN's application ID/port number 119, and the QoS 127 for the session. The AAA server 108 responds with an Accounting response message 150 confirming the start of a new accounting event related to the data session. At that time, the PDSN 103 may start counting any traffic, action 153, on the data session between the CN 110 and the MS 102. The P-CSCF 104 releases a SIP 2000K final response message 152 to the origination MS 102, which then starts the media flows for the present packet data session, action 160. The packet data session is started as the MS 102 sends acknowledgment message 162 to the CN 110. in case of a prepaid charging being decided, the AAA server 108 may then issue charging messages to the billing center 109 for creating billing records, action 151, for the data session based on information received in interim messaged of the same type as message 148, but further comprising interim data volumes exchanged during the session.

Once the MS 102 has, for example, obtained all the required information from the CN 110, it may end the packet data session by sending a SIP BYE message 164 to the CN 110, which message terminates the data session. The PDSN 103 may be notified of the terminated data session via a special COPS DECISION message 165, initiated by the P-CSCF 104 and triggered by the receipt of the SIP BYE message 164, wherein the message 165 may comprise a Remove command with parameters associated to the terminated data session, so that the PDSN 103 is notified of the terminated data session and can terminate any context and accounting related to that session. Knowing that the session is ended, the PDSN 103 also sends to the AAA server 108 an Accounting Stop message 170 comprising a Final Stop parameter 171 indicative of the termination of the data session, the session ID 147, and the final data volume 173 used for the session. Part of action 151, the AAA server and the billing center 109 perform charging for the amount of data 173 exchanged during the data session based on the information related to the CN 110, including the CN's IP address 118, the application ID/port number 119, and optionally the QoS 127 for the data session. The AAA server 108 acknowledges receipt of message 170 with an. Accounting Response message 172.

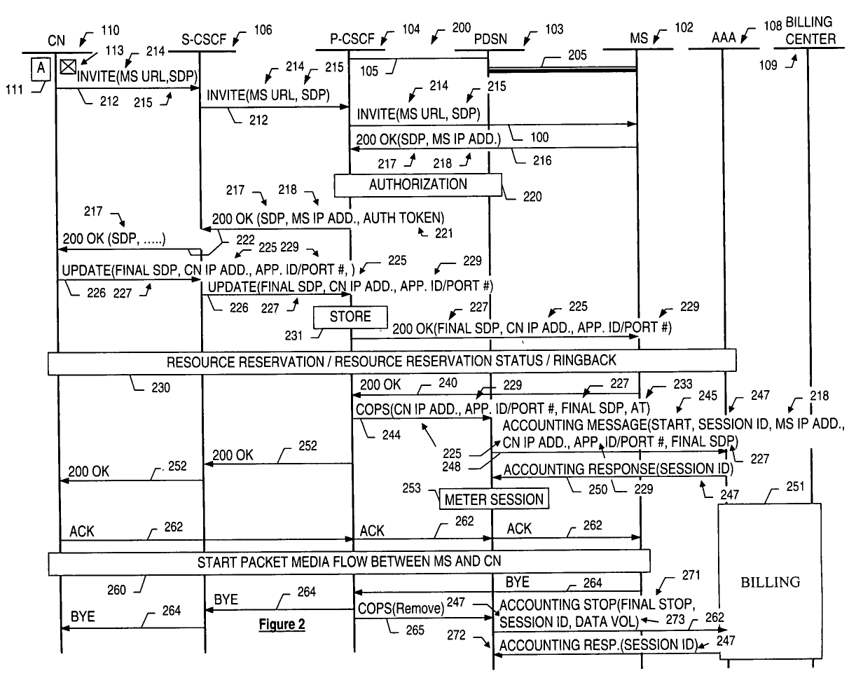

Reference is now made to FIG. 2, which is a nodal operation and signal flow diagram of an exemplary packet data network 200, similar to the network 100 previously described, implementing the preferred embodiment of the present invention associated with the termination of a packet data session to an MS. The exemplary network 200 may be a CDMA2000 network that comprises the MS 102, the PDSN 103, the P-CSCF 104, the S-CSCF 106, the AAA server 108, the CN 110, the billing center 109, and the interface 105 as described hereinbefore with reference to FIG. 1. The MS 102 is also assumed to be able to establish packet data sessions with the CN 110 that runs at least an application 111 communicating via a port 113 with network entities external to the CN.

With reference being further made to FIG. 2, the MS 102 is originally attached to the PDSN 103 via a PPP data session. At one point in time, an originating party, herein assumed to be the CN 110, initiates the establishment of an MMS data session with the MS 102 using SIP signalling, by sending a SIP INVITE message 212 comprising an MS URL 214 identifying the MS with which the CN desires to establish a data session, as well as SDP parameters 215 to the S-CSCF 106. The SDP 215 is used to provide to the called party the information necessary to join a session. This information may comprise the media types and formats that are allowed within the session as well as session information such as session identification, network type, address type and address elements. The S-CSCF 106 validates the service profile of the MS 102, and performs any termination service control required for the MS 102 (actions not shown). This may include authorization of the requested SDP session parameters based on the user's subscription for MMS. The S-CSCF 106 forwards the INVITE message 212 to the P-CSCF 104, which further sends the SIP INVITE message 212 to the MS 102, which may determine a subset of media flows proposed by the originating endpoint (i.e. the CN 110) that it supports, and responds back to the CN 110 with a 2000K message 216 with the subset of media flows forming a set of SDP media stream capabilities 217 determined by the MS 102, as well as with the MS IP address 218.

In action 220, the P-CSCF 104, possibly in combination with the PDSN 103, authorizes the resources necessary to the data session and may further generate, as a result of the authorization 220, an authorization token 221, which is then forwarded in a 2000K message 222 to the originating CN 110 along with the SDP media stream capabilities 217 determined by the MS 102, and the MS IP address 218. Based on the SDP media stream capabilities 217 received in message 222, the CN 110 decides the final set of media streams settings for the data session, and issues a SIP UPDATE message 226 that according to the present invention may comprise the final choice for the SDP media stream capabilities 227, the CN IP Address 225, and the application ID/port number 229 used by the CN 110. The UPDATE message 226 is sent via the P-CSCF 104 and the S-CSCF 106, to the MS 102. The P-CSCF 104 stores the CN related information, i.e. the SDP media stream capabilities 227, the CN IP Address 225, the application ID/port number 229 used by the CN 110 in action 231.

In action 230, the CN 110 initiates the reservation procedures for the resources needed for this data session. Part of action 230, when the resources' reservation is completed, the CN 110 may send a resource reservation successful message to the MS 102, via signalling established by the SIP INVITE message 212. The resources reservation successful message is also sent through the P-CSCF 104 and the S-CSCF 106 to the MS 102, which may optionally perform ringing/alerting, in which situation the MS 102 receives, via the S-CSCF 106 and the P-CSCF 104, a provisional response indicating ringing. When the MS 102 answers, it sends a SIP 2000K final response 240 to the P-CSCF 104, which may perform whatever service control is further appropriate for the session setup. According to the invention, the P-CSCF 104 indicates the resources reserved for this data session should now be committed by communicating with the PDSN 103 via, for example, a COPS message 244 of the type previously described with reference to FIG. 1, wherein the message 244 may comprise the final SDP media stream capabilities 227, the CN IP Address 225, the application ID/port number 229 used by the CN 110, as well as the Accounting Type (AT) 233 (e.g. prepaid vs postpaid). In one variant, the COPS message 244 may be a COPS DECISION message comprising an Install command with the parameters of the CN's related information, although it is understood that the message 144 may be of any other type as well and comprise other parameters as well.

The PDSN 103 then sends an Accounting Start message 248 to the AAA server 108, for informing the former of the new data session that is being established, the message comprising a start parameter 245 indicative of a new accounting session, a session ID parameter 247 identifying the new session, the MS IP address 218, the CN IP address 225, the CN's application ID/port number 229, and the final SDP parameters 227 including the QoS for the session. The AAA server 108 responds with an Accounting response message 250 confirming the start of a new accounting event related to the data session. At that time, the PDSN 103 may start counting any traffic on the data session between the CN 110 and the MS 102, action 253. Finally, the P-CSCF 104 releases a SIP 2000K final response message 252 to the origination CN 110, which then starts the media flows for the present packet data session, action 260. The packet data session is started as the MS 102 sends acknowledgment message 262 to the MS 102. In case of a prepaid accounting type, the AAA server 108 may then issue charging messages to the billing center 109 for creating billing records, action 251, for the data session based on information received in interim messages alike message 248, but comprising interim accounts of the data volume exchanged during the session.

Once the MS 102 has, for example, obtained all the required information from the CN 110, it may end the packet data session by sending a SIP BYE message 264 to the CN 110, which message terminates the session. The PDSN 103 is notified of the terminated data session via a special COPS DECISION message 265, initiated by the P-CSCF 104 and triggered by the receipt of the SIP BYE message 264, wherein the message 265 may comprise a Remove command with parameters associated to the terminated data session, so that the PDSN 103 is notified of the terminated data session and can terminate any context and accounting related to that session. Upon receipt of the message 265, the PDSN 103 terminates the context and accounting associated to the data session, and sends to the AAA server 108 an Accounting Stop message 270 comprising a Final Stop parameter 271 indicative of the termination of the data session, the session ID 247, and the final data volume 273 exchanged for the session. Part of action 151, the AAA server and the billing center 109 perform charging for the amount of data 273 exchanged during the data session based on the information related to the CN 110, including the CN's IP address 118, the application ID/port number 119, and optionally the QoS 227 for the data session.

The AAA server 108 may finally respond to the message 170 with an Accounting Response message 272.

Therefore, with the current invention applied to both an originating and a terminating data session carried by an MS registered with a PDSN, it becomes possible to report information related to a CN involved in the same data session, including the CN's IP address, the CN's application ID or port number, and the QoS for the data session, to the PDSN, and from that point to the AAA server responsible for the charging. Having knowledge not only of the MS related information like in the prior art, but also of the CN's related information, it becomes possible for the AAA server to apply a new, flexible and specific charging scheme, which is (also) based on the CN that participated to the data session.

Based upon the foregoing, it should now be apparent to those of ordinary skills in the art that the present invention provides an advantageous solution, which allows for specific accounting based on a remote IP address of a CN in data communication with a first IP-based terminal, such as for example the previously described MS 102. Although the system and method of the present invention have been described in particular exemplary reference to a CDMA2000 network, it should be realized upon reference hereto that the innovative teachings contained herein are not necessarily limited thereto and may be implemented advantageously with any wireline or wireless (or a combination there between) packet data network, beyond the CDMA2000 example stated herein, such as for example GPRS, eGPRS systems or UMTS (WCDMA) networks. For example, the MS 102 described in FIGS. 1 and 2 may be any kind of IP-based terminal (e.g. PC, laptop, Handheld device, PDA, Mobile Node, etc), while the PDSN can be replaced by any other type of packet data access node for an IP-based terminal), such as for example GGSN, SGSN, or any IP router performing accounting functions. It is believed that the operation and construction of the present invention will be apparent from the foregoing description. While the method and system shown and described have been characterized as being preferred, it will be readily apparent that various changes and modifications could be made therein without departing from the scope of the invention as defined by the claims set forth hereinbelow.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for charging in a packet data system, the method comprising the steps of:
a) initiating a packet data session between an IP-based terminal having assigned an MS IP address, and an IP-based Corresponding Node (CN) having assigned a CN IP address;
b) providing a Packet Data Access Node (PDAN) with CN's related information including the CN IP address;
c) using the CN IP address of the CN, determining by the PDAN an amount of data exchanged by the CN with the MS during the packet data session; and
d) reporting the amount of data from the PDAN to an Authorization, Authentication, and Accounting server (AAA).

2. The method claimed in claim 1, wherein the CN's related information further includes an indication of an application used by the CN for communicating over the data session, and wherein in step d), the PDAN reports to the AAA both the amount of data and the indication of the application used by the CN.

3. The method claimed in claim 2, wherein the indication of the application used by the CN comprises a port number used by the CN for communicating over the data session.

4. The method claimed in claim 1, wherein the CN's related information further includes an indication of a Quality of Service (QoS) used for communicating over the data session, and wherein in step d), the PDAN reports to the AAA the amount of data and the indication of the QoS.

5. The method claimed in claim 1, wherein the packet data session is an IP Multimedia (IPMM) session, and step a) comprises the step of:
a.1) initiating the IPMM session using a Session Initiation Protocol (SIP) signalling between the IP-based terminal and the IP-based CN;
and wherein step b) comprises the step of:
b.1) receiving the CN IP address by a Proxy Call Sate Control Function (P-CSCF); and
b.2) transmitting the CN IP address from the P-CSCF to the PDAN.

6. The method claimed in claim 5, wherein the CN IP address is sent from the P-CSCF to the PDAN over an IP communication interface that connects the P-CSCF to the PDAN.

7. The method claimed in claim 5, wherein the IP-based terminal is a Mobile Station (MS).

8. The method claimed in claim 5, wherein the IP-based CN is a Mobile Station (MS).

9. The method claimed in claim 5, wherein the IP-based CN is an IP-based content provider server.

10. The method claimed in claim 6, wherein the packet data system is a Code Division Multiple Access 2000 (CDMA2000) wireless network and the PDAN is a Packet Data Serving Node (PDSN) of the CDMA2000network.

11. The method claimed in claim 1 further comprising, prior to step d), the step of:
e) terminating the packet data session;
wherein the amount of data is the total amount of data exchanged by the CN with the MS during the packet data session.

12. The method claimed in claim 1, wherein the IP-based terminal initiates the packet data session with the IP-based CN.

13. The method claimed in claim 1, wherein the IP-based CN initiates the packet data session with the IP-based terminal.

14. A packet data system comprising:
an IP-based terminal having assigned a terminal IP address;
an IP-based Corresponding Node (CN) having assigned a CN IP address;
a Packet Data Access Node (PDAN); and
an Authorization, Authentication, and Accounting server (AAA);
wherein when a packet data session is established between the IP-based terminal and the IP-based CN, the PDAN is provided with CN's related information including the CN IP address and based on the CN IP address, the PDAN determines an amount of data exchanged by the CN with the MS during the packet data session, and reports the amount of data to the AAA server.

15. The packet data system claimed in claim 14, wherein the CN's related information further includes an indication of an application used by the CN for communicating over the data session, and wherein the PDAN reports to the AAA both the amount of data and the indication of the application used by the CN.

16. The packet data system claimed in claim 15, wherein the indication of the application used by the CN comprises a port number used by the CN for communicating over the data session.

17. The packet data system claimed in claim 14, wherein the CN's related information further includes an indication of a Quality of Service (QoS) used for communicating over the data session, and wherein the PDAN reports to the AAA the amount of data and the indication of the QoS.

18. The packet data system claimed in claim 14, further comprising:
Proxy Call Sate Control Function (P-CSCF);
wherein the packet data session is an IP Multimedia Services (MMS) session initiated using a Session Initiation Protocol (SIP) signalling between the IP-based terminal and the IP-based CN, and wherein the CN's related information is provided to the PDAN by the P-CSCF.

19. The packet data system claimed in claim 18, further comprising:
an IP communication interface that connects the P-CSCF to the PDAN;
wherein the CN's related information is sent from the P-CSCF to the PDAN over the IP communication interface.

20. The packet data system claimed in claim 18, wherein the IP-based terminal is a Mobile Station (MS).

21. The packet data system claimed in claim 18, wherein the IP-based CN is a Mobile Station (MS).

22. The packet data system claimed in claim 18, wherein the IP-based CN is an IP-based content provider server.

23. The packet data system claimed in claim 19, wherein the packet data system is a Code Division Multiple Access 2000 (CDMA2000) wireless network and the PDAN is a Packet Data Serving Node (PDSN) of the CDMA2000network.

24. The packet data system claimed in claim 14 wherein before reporting the amount of data to the AAA server, one of the IP-based MS and the IP-based CN terminates the packet data session, wherein the amount of data is the total amount of data exchanged by the IP-based CN with the IP-based MS during the packet data session.

25. The packet data system claimed in claim 14, wherein the IP-based terminal initiates the packet data session with the IP-based CN.

26. The packet data system claimed in claim 14, wherein the IP-based CN initiates the packet data session with the IP-based terminal.

27. A Packet Data Access Node (PDAN) acting to support a packet data session between an IP-based terminal having assigned a terminal IP address and an IP-based Corresponding Node (CN) having assigned a CN IP address, wherein when a packet data session is established between the IP-based terminal and the IP-based CN, the PDAN receives CN's related information including the CN IP address and, based on the CN IP address, the PDAN determines an amount of data exchanged by the CN with the MS during the packet data session, and reports the amount of data to an Authorization, Authentication, and Accounting server (AAA).

28. The PDAN claimed in claim 27, wherein the CN's related information further includes an indication of an application used by the CN for communicating over the data session, and wherein the PDAN reports to the AAA both the amount of data and the indication of the application used by the CN.

29. The PDAN claimed in claim 28, wherein the indication of the application used by the CN comprises a port number used by the CN for communicating over the data session.

30. The PDAN claimed in claim 27, wherein the CN's related information further includes an indication of a Quality of Service (QoS) used for communicating over the data session, and wherein the PDAN reports to the AAA the amount of data and the indication of the QoS.

31. The PDAN claimed in claim 27, wherein the packet data session is an IP Multimedia (IPMM) session and wherein the CN IP address is provided to the PDAN by a Proxy Call Sate Control Function (P-CSCF).

32. The PDAN claimed in claim 31, wherein the PDAN is connected to the P-CSCF via an IP communication interface, wherein the CN IP address is sent from the P-CSCF to the PDAN over the IP communication interface.

33. The PDAN claimed in claim 32, wherein the IP-based terminal is a Mobile Station (MS).

34. The PDAN claimed in claim 32, wherein the IP-based CN is a Mobile Station (MS).

35. The PDAN claimed in claim 32, wherein the IP-based CN is an IP-based content provider server.

36. The PDAN claimed in claim 33, wherein the PDAN is a Packet Data Serving Node (PDSN) that functions in a Code Division Multiple Access 2000 (CDMA2000) wireless network.

37. The PDAN claimed in claim 27, wherein before reporting the amount of data to the AAA server, one of the IP-based terminal and the IP-based CN terminates the packet data session;
wherein the amount of data is the total amount of data exchanged by the IP-based CN with the IP-based terminal during the packet data session.

38. The PDAN claimed in claim 27, wherein the IP-based terminal initiates the packet data session with the IP-based CN.

39. The packet data system claimed in claim 27, wherein the IP-based CN initiates the packet data session with the IP-based terminal.
